(19) United States
(12) Patent Application Publication
(10) Pub. No.: US 2016/0208981 A1
(43) Pub. Date: Jul. 21, 2016

(54) ACCESSORY MOUNT

(71) Applicant: David Michael Kaesemeyer, Clarksville, OH (US)

(72) Inventor: David Michael Kaesemeyer, Clarksville, OH (US)

(21) Appl. No.: 14/598,246

(22) Filed: Jan. 16, 2015

(51) Int. Cl. F16M 13/02; F16B 2/12; F21V 21/08; B08B 1/00; B05B 15/06; B25G 3/04; B08B 3/02

(52) U.S. Cl. CPC F16M 13/022; B25G 3/04; F16B 2/12; B08B 3/026; B08B 1/001; B08B 1/005; B08B 1/002; B05B 15/061; F21V 21/08

(57) ABSTRACT

An accessory mount includes a clamp with a threaded shank attached to a clamp knob for securing together upper and lower clamp bodies and a means for removably mounting one or more accessories such as a detachable and angularly adjustable hand grip on one of the bodies. Mating rosettes may pivotably mount the hand grip to one of the bodies. An attachment such as a wheeled support with a wheel rotatably supported at a bottom end of a strut includes a connector removably mounting the strut to the hand grip. The accessories may include a mounting block carrying at least one nozzle tip holder and/or a flashlight holder. Nozzle tip holder may include a bore circumscribing an axis and extending through the holder and flexible spiral holding fingers extending radially inwardly and circumferentially into the bore from a rim around the bore.

### CROSS-REFERENCE TO RELATED APPLICATIONS

The present application claims priority to U.S. Provisional Patent Application Ser. No. 61/928,587, entitled “Multi-Tool Device for a Pressure Washer Wand”, filed Jan. 17, 2014, the disclosure of which is hereby incorporated by reference.

### BACKGROUND OF THE INVENTION

1. Field of the Invention

The present invention relates generally to mounts for tubes such as pressure washer wands and attachments thereto.

2. Description of Related Art

Pressure washers provide a highly-pressurized spray of water, or other liquid, through tubes or wands for cleaning or other purposes. One or more accessories may be mounted to the wand such as a wheeled support or hand tools used by the operator of the pressure washer to facilitate the cleaning. It is highly desirable to have such mounts that are reliable, strong, and easy to mount to and remove from the tubular members.

### BRIEF SUMMARY

An accessory mount includes a clamp including upper and lower clamp bodies, a clamp bolt or a clamp threaded shank attached to and extending away from a clamp knob for securing together the upper and lower clamp bodies, and a means for removably mounting one or more accessories on one of the upper and lower clamp bodies. One of the accessories may include a detachable and angularly adjustable hand grip. The upper and lower clamp bodies may include upper and lower V-shaped clamp walls respectively.

Mating rosettes may be used for pivotably mounting the hand grip to one of the upper and lower clamp bodies. The mating rosettes includes a body rosette on one of the upper and lower clamp bodies and an accessory rosette on the hand grip. A mounting threaded shank disposed through an aperture in the hand grip and attached to and extending away from a mounting knob is used for securing together the mating rosettes.

The accessory mount may include an attachment having a strut and a connector for removably mounting the strut to the hand grip. The attachment may be a wheeled support including a wheel rotatably supported at a bottom end of the strut. Alternative attachments may be chosen from a group of attachments comprising of a squeegee, a brush, and a scraper.

The accessories may include a mounting block carrying at least one nozzle tip holder and/or a flashlight holder and may further include a hanger having a hoop or attachment slot on the clamp. The hanger is operable to receive a hook on the mounting block and includes a quick release thumb tab on the hook operable to be disposed in the attachment slot and engage the hanger.

The nozzle tip holder may include a bore circumscribing an axis and extending through the holder and flexible spiral holding fingers extending radially inwardly and circumferentially into the bore from a rim around the bore. The spiral fingers may spiral into the bore, narrow down from wide circular finger bases along an inner boundary around the bore, and be spaced evenly or equiangularly circumferentially around the inner boundary. The spiral fingers may include scalloped ends with curved or circular gripping surfaces, the circular gripping surfaces being circularly circumscribed about the axis, and the circular gripping surfaces defining a cylindrical bore core circumscribing the axis.

A pressure washer wand and accessory mount assembly includes an accessory mount having a clamp having upper and lower clamp bodies clamped around a longitudinally extending tube of a pressure washer wand. A clamp bolt or a clamp threaded shank is attached to and extends away from a clamp knob for securing together the upper and lower clamp bodies. The assembly includes a means for removably mounting one or more accessories on at least one of the upper and lower clamp bodies.

The accessories may include a detachable and angularly adjustable hand grip. The upper and lower clamp bodies may include upper and lower V-shaped clamp walls respectively clamped around the longitudinally extending tube.

### BRIEF DESCRIPTION OF THE DRAWINGS

The detailed description particularly refers to the accompanying figures in which:

FIG. 1 is a perspective view illustration of an accessory mount mounted on a pressure washer wand.

FIG. 2 is a perspective view illustration of the accessory mount with a wheeled support mounted thereto illustrated in FIG. 1.

FIG. 3 is an exploded perspective view illustration of the accessory mount and wheeled support with respect to the wand illustrated in FIG. 1.

FIG. 3A is an exploded perspective view illustration of a lock to secure the wheeled support to a lower clamp body of the accessory mount illustrated in FIG. 3.

FIG. 4 is a perspective side view illustration of various mounting positions of the accessory mount on the wand illustrated in FIG. 1.

FIG. 5 is a perspective side view illustration of various angular positions of a hand grip mounted to the accessory mount on the wand illustrated in FIG. 1.

FIG. 6 is a perspective side view illustration of the hand grip mounted to the accessory mount on the wand illustrated in FIG. 1.

FIG. 7 is a perspective side view illustration of a mounting block carrying a nozzle tip holder and a flashlight holder for mounting on the accessory mount on the wand illustrated in FIG. 1.

FIG. 7A is a diagrammatic view illustration of spiral fingers in the nozzle tip holder illustrated in FIG. 7.

FIG. 8 is a perspective side view illustration of the mounting block mounted on the accessory mount illustrated in FIG. 7.

FIG. 9 is a perspective side view illustration of a flashlight for sliding into elastic loops of the flashlight holder illustrated in FIG. 7.

FIG. 10 is a perspective side view illustration of the flashlight mounted in the elastic loops of the flashlight holder illustrated in FIG. 9.

FIG. 11 is a perspective view illustration of a prior art pressure washer wand.

FIG. 12 is a perspective view illustration of an operator using wand with the wheeled support illustrated in FIG. 1.

FIG. 13 is a perspective view illustration of an operator using wand with the wheeled support illustrated in FIG. 1 on siding on a house.

FIG. 14 is a perspective view illustration of a squeegee attachment for mounting to the accessory mount illustrated in FIG. 1.

FIG. 15 is a perspective view illustration of a scraper attachment for mounting to the accessory mount illustrated in FIG. 1.

FIG. 16 is a perspective view illustration of a brush attachment for mounting to the accessory mount illustrated in FIG. 1.

### DETAILED DESCRIPTION OF THE INVENTION

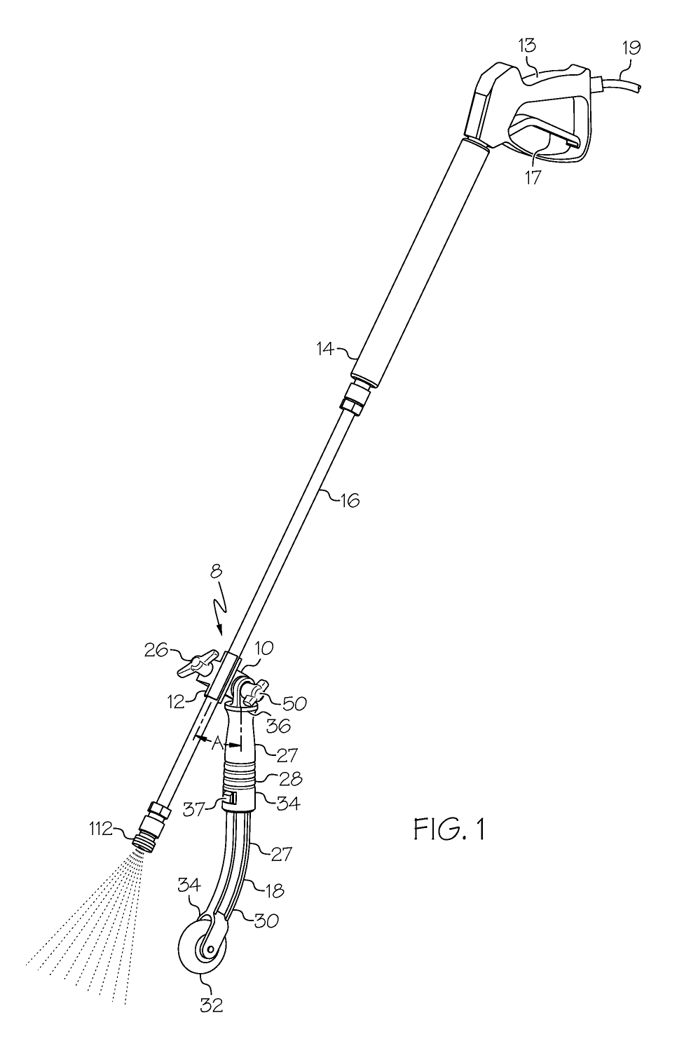

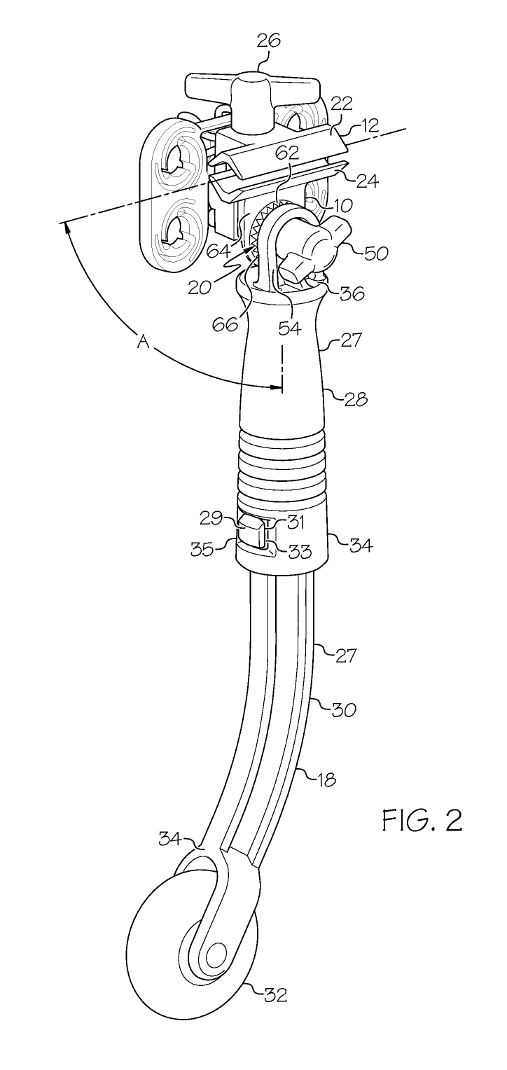

Illustrated in FIGS. 1 and 2 is an exemplary embodiment of a pressure washer wand and accessory mount assembly 8 having an accessory mount 10 including a clamp 12 mounted on a longitudinally extending tube 16 of a wand 14 of a portable pressure washer not shown herein. The wand 14 is attached to a washer handle 13 which includes a trigger 17 to open and close a valve inside the handle 13. A washer hose 19 is connected in fluid supply flow to the valve inside the handle 13. The exemplary accessory mount 10 illustrated in FIGS. 1 and 2 mounts and secures one or more accessories 27, such as an adjustable hand grip 28, to the tube 16.

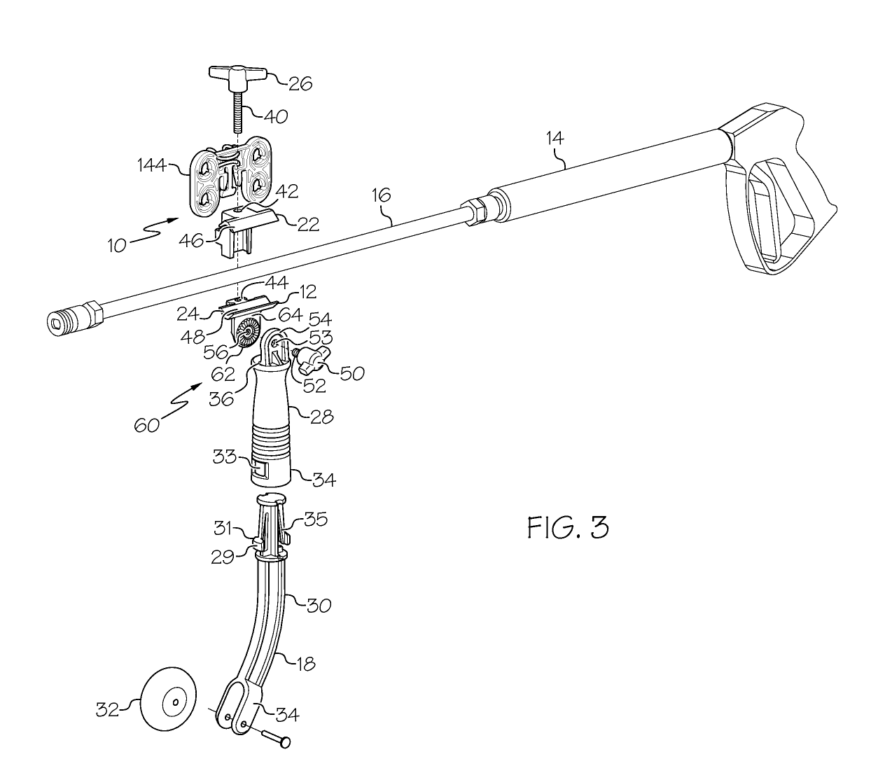

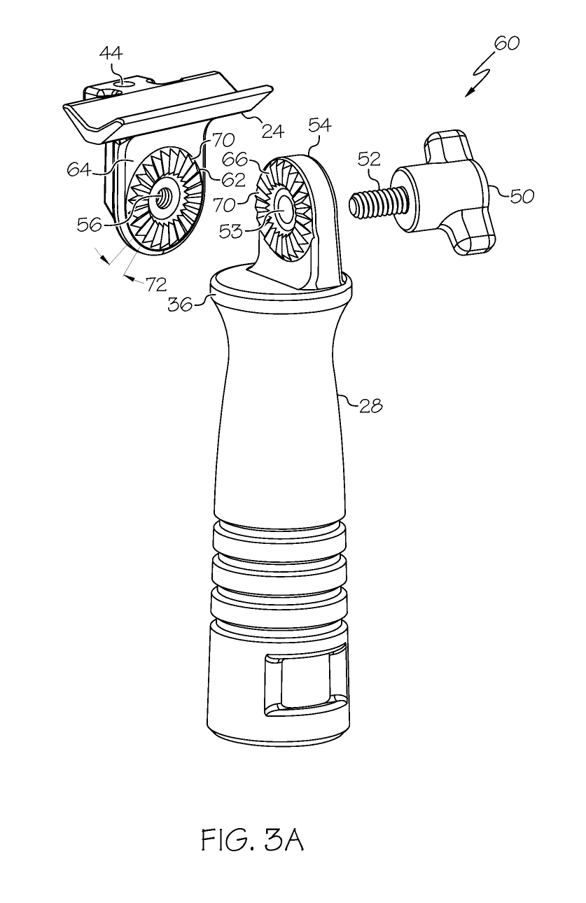

An additional accessory or attachment illustrated in FIGS. 1 and 2 is a wheeled support 18 including a strut 30 removably mounted to a bottom end 34 of the hand grip 28. A wheel 32 is rotatably mounted to a bottom end 34 of the strut 30. A slip fit snap connector 35, illustrated in FIGS. 2 and 3, may be used to connect the strut 30 to the hand grip 28 and may be easily removed by depressing a thumb tab 29 of the connector. The strut 30 may be slid into and securely received inside the hand grip 28 and locked in place using a thumb tab release 31. The thumb tab 29 is operable to engage a tab hole 33 in the hand grip 28.

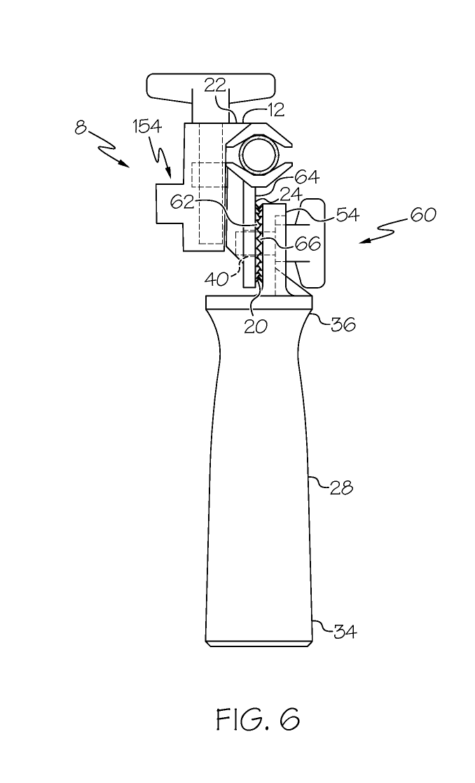

A top end 36 of the hand grip 28 is mounted to the clamp 12 as illustrated in FIGS. 1-3 and 6. The clamp 12 includes upper and lower clamp bodies 22, 24 that are secured together by a clamp bolt or a threaded shank 40 attached to and extending away from a clamp knob 26. The threaded shank 40 passes through a pass through hole 42 and is screwed into a threaded hole 44 in the lower clamp body 24 to secure the accessory mount 10 to the tube 16 of the wand 14. The clamp knob 26 may be elongated as illustrated herein or it may be rounded and it may be knurled.

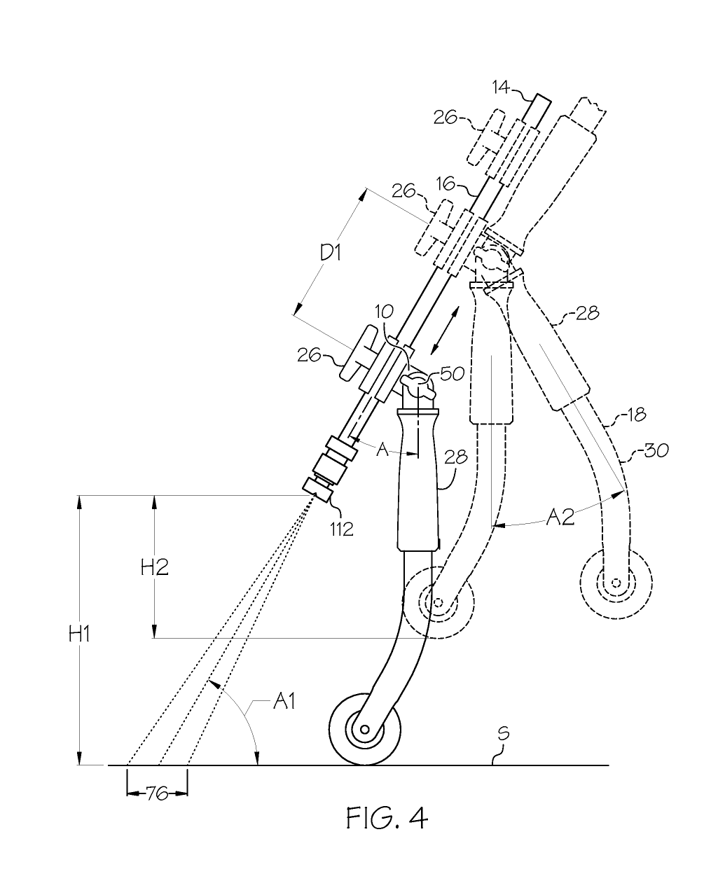

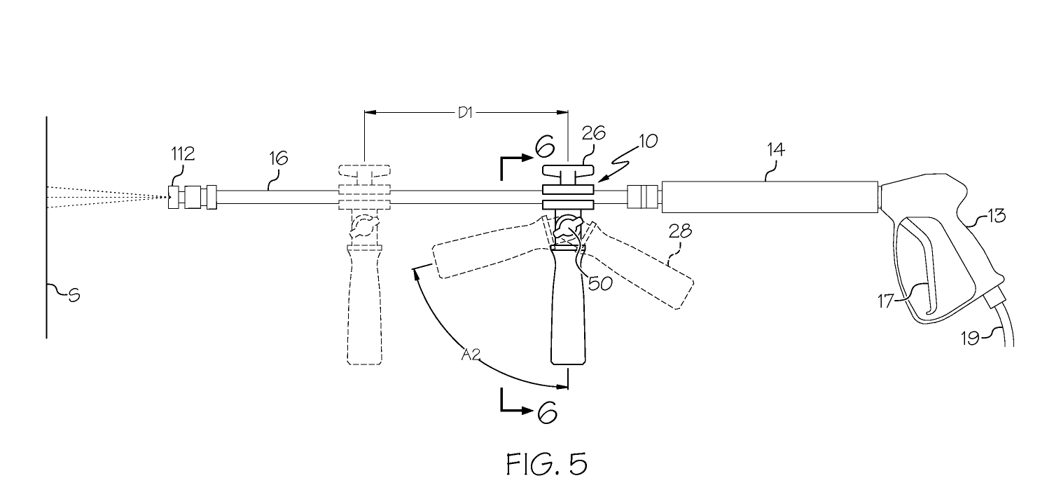

The tube 16 may be clamped between upper and lower V-shaped clamp walls 46, 48 of the upper and lower clamp bodies 22, 24 respectively. The accessory mount 10 can be repositioned anywhere along the length of the tube 16 of the wand 14 by simply loosening the clamp knob 26 to unclamp or loosen the accessory mount 10 from the tube 16. Illustrated in FIGS. 4 and 5 are two different positions of the accessory mount 10 and the hand grip 28 along the tube 16 illustrated in solid and dashed lines respectively and separated by a distance D1. This allows the accessory mount 10 to be slid up or down a length of the wand 14 and be easily and securely relocated anywhere an operator wants it. This also allows the nozzle tip 112 to be set to different heights above the work surface S as illustrated by first and second heights H1 and H2.

Referring to FIGS. 2 and 3, the top end 36 of the hand grip 28 is illustrated as being mounted to the lower clamp body 24. Mating rosettes 20 may be used to pivotably mount the hand grip 28 to the clamp 12 as further illustrated in FIGS. 2, 3, 3A, and 6. A mounting knob 50 engages a mounting frame 54 at the top end 36 of the hand grip 28. A threaded shank 52 attached to the mounting knob 50 is disposed through an aperture 53 in the mounting frame 54 and engages a threaded hole 56 in the lower clamp body 24. The hand grip 28 is rotatable about the threaded hole 56 and may be set to different angular positions indicated by a differential angle A2 as illustrated in FIGS. 4 and 5. The mounting knob 50 may be elongated as illustrated herein or it may be rounded and it may be knurled.

Referring to FIGS. 2, 3, 3A, and 6, a lock 60 to secure the hand grip 28 to the lower clamp body 24 helps set and maintain an accessory angle A of the hand grip 28 and the strut 30 relative to the tube 16. The lock 60 may include the pair of mating rosettes 20 which include a body rosette 62 on a surface 64 of the lower clamp body 24 and an accessory rosette 66 on the mounting frame 54 of the hand grip 28. The accessory rosette 66 is designed to mate with the body rosette 62 to provide incremental angular positioning, indicated by A2 in FIGS. 4 and 5, of the hand grip 28 and the strut 30 relative to the tube 16 and the lower clamp body 24 of the clamp 12. The two rosettes are preferably substantially identical and may have identically angled radial ribs 70 and rib widths 72.

The hand grip 28 may be used by itself to help assist gripping the wand when used in a horizontal position on surfaces such as siding on a house as illustrated in FIG. 13. The hand grip 28 provides the operator 38 an additional fully adjustable knob to grip which provides improved control of the wand 14 resulting in less fatigue and increased efficiency. The hand grip 28 can provide an insulated grip for hot water pressure washers.

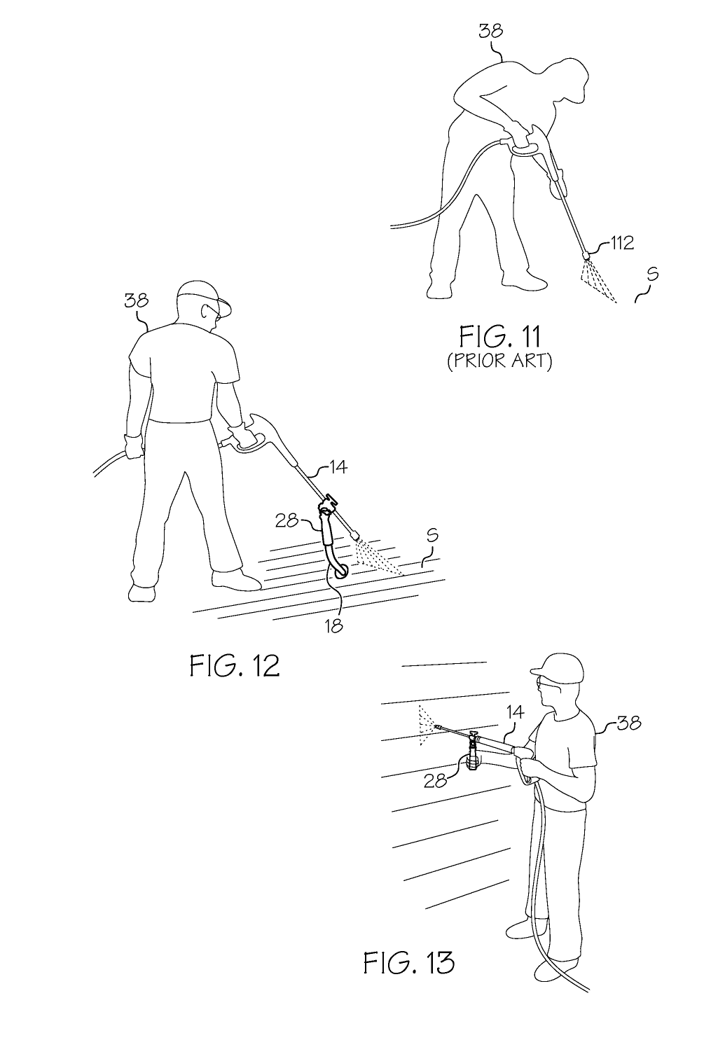

The wheeled support 18 (which attaches to the bottom of the hand grip 28) is used to help assist the operator 38 when used in an upright position on surfaces S such as a driveway or a deck as illustrated in FIG. 12. Typically, a operator 38 has to hold the wand's nozzle tip 112 at a set distance above the work surface S, as illustrated in FIG. 11, and work his way back and forth when cleaning an area. This usually requires both hands to keep the path and width of spray consistent. This can be very strenuous on the back when trying to hold the wand up off the ground and can cause the operator 38 to slow down and rest.

The accessory mount 10 with the wheeled support 18 attached can be positioned anywhere along the length of the tube 16 of the wand 14 as illustrated in FIG. 4. The accessory angle A of wheeled support 18 in relation to the wand is also fully adjustable so that any position is possible. As illustrated in FIG. 12, the wand 14 with the accessory mount 10 and the wheeled support 18 attached thereto is easily controlled and pushed around with just one hand instead of having to hold it up in the air above the work surface S. This eliminates the operator 38 having to strain and hold the wand up above the work surface by using the wheel to support the weight of the wand instead. The spray tip 112 is more easily kept at the same height, such as at the first or second heights H1 and H2, giving the operator 38 a more consistent spray width 76 and path as indicated by a spray angle A1. It also reduces or eliminates any accidental gouging of the work surface if the nozzle tip 112 gets too close. With no weight of the wand to hold up and a more consistent spray width path, a operator 38 can cover an area much faster and with less fatigue. The strut 30 of the wheeled support 18 may be curved and can be inserted into the end of the handle grip either curved forwardly or curved rearwardly to meet a operator's specific needs. The wheeled support can also be used in the vertical position as well (such as siding on a house) which can help prevent the nozzle tip 112 from getting too close to the work surface.

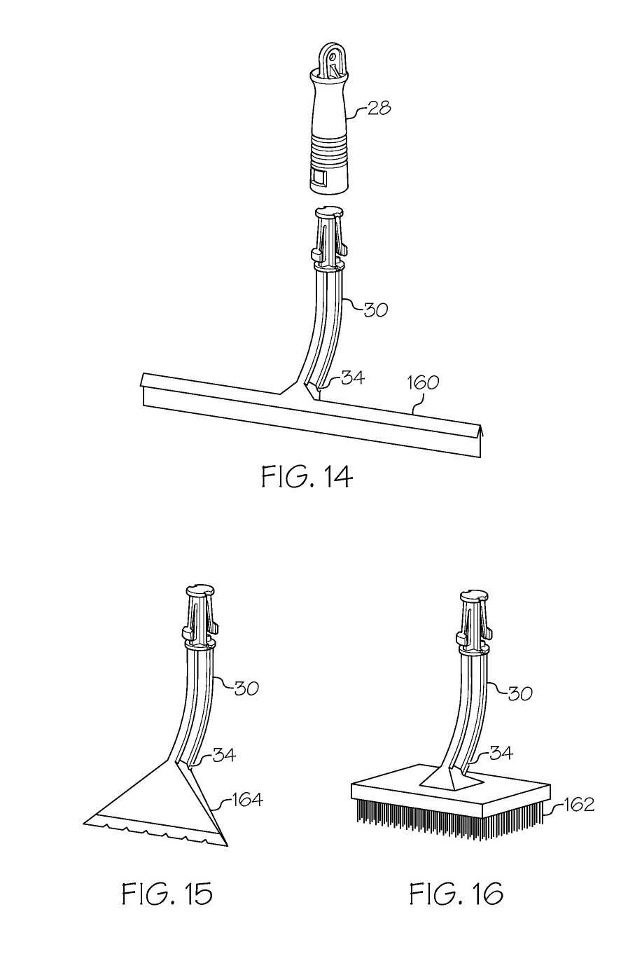

The end of the handle grip can also accept other attachments or accessories besides the wheeled support. Examples of such other attachments or accessories include, but are not limited to, a squeegee 160 at the bottom end 34 of the strut 30 as illustrated in FIG. 14, a brush 162 at the bottom end 34 of the strut 30 as illustrated in FIG. 15, a scraper 164 at the bottom end 34 of the strut 30 as illustrated in FIG. 16, or other suitable accessories or attachments.

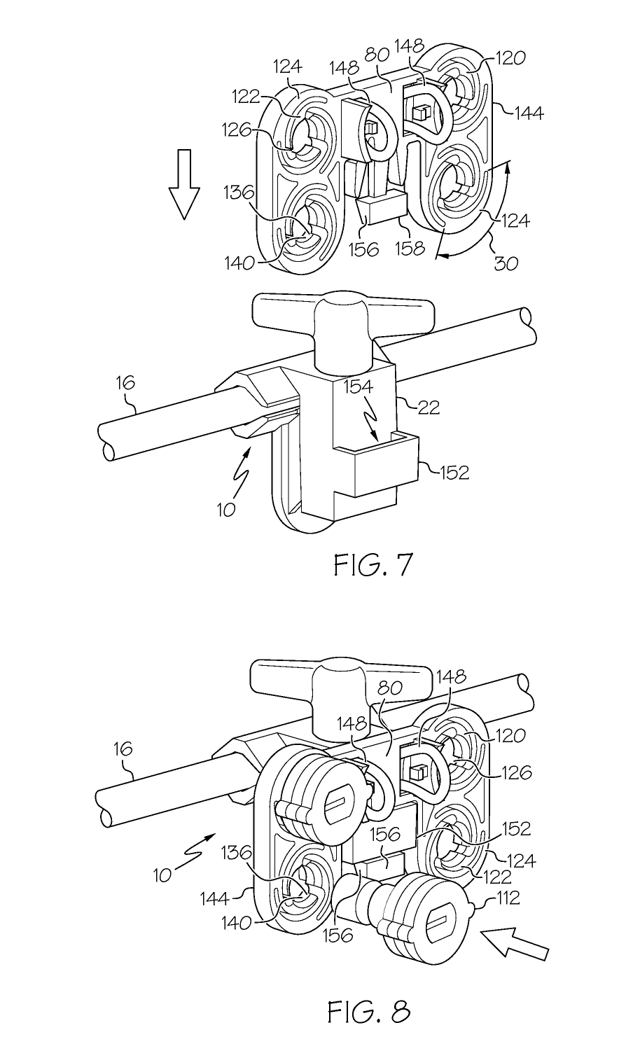

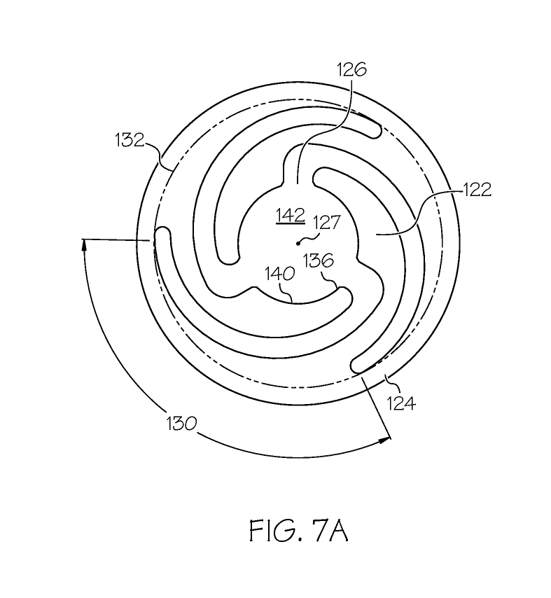

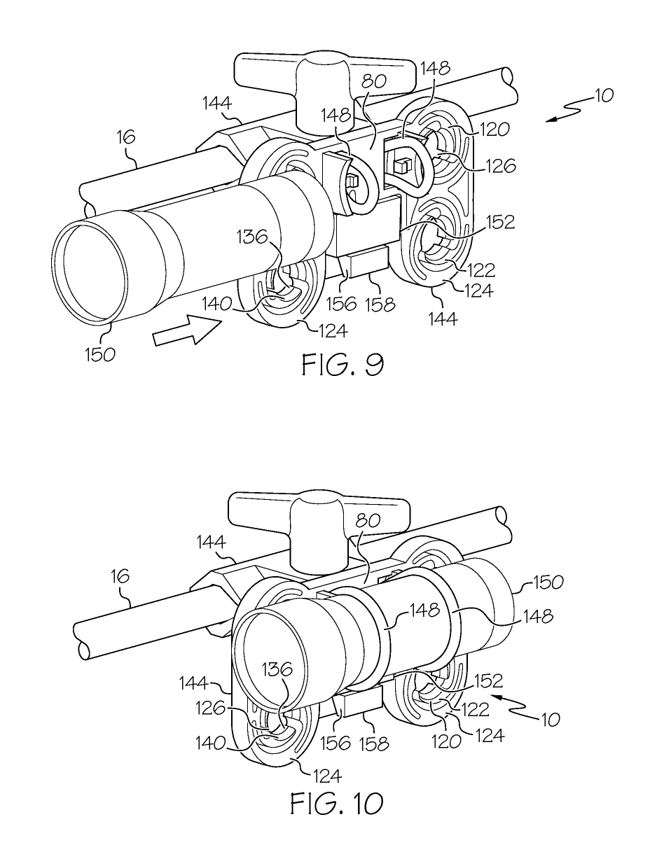

Referring to FIGS. 3 and 7-10, the accessory mount 10 may include a mounting block 144 carrying one or more nozzle tip holders 120 and/or a flashlight holder 80 as illustrated in FIGS. 7-10. The flashlight holder 80 and the nozzle tip holder 120 are both mounted on the mounting block 144. The flashlight holder 80 includes at least two longitudinally spaced apart elastic loops 148 attached to the mounting block 144. A flashlight 150 can be slid into and secured by the elastic loops 148 as illustrated in FIGS. 9 and 10. Attaching a flashlight directly to the wand helps illuminate the work area and spray path when it gets dark when there are no other lights around, thereby, increasing a operators ability to complete a job after it gets dark.

Referring to FIGS. 7-10, the upper clamp body 22 includes a hanger 152 having a hoop or attachment slot 154 operable to receive a hook 156 on the mounting block 144. The hook 156 attaches and is secured to the upper clamp body 22 by a quick release thumb tab 158 on the hook 156. The quick release thumb tab 158 is disposed in the attachment slot 154 and engages the hanger 152.

Illustrated in FIGS. 7-10 is a pair of nozzle tip holders 120 on the mounting block 144. The nozzle tip holders 120 include spiral holding fingers 122 extending radially inwardly and circumferentially from a rim 124 and into a bore 126 circumscribing an axis 127 as further illustrated in FIG. 7A. The spiral holding fingers 122 curve circumferentially about the axis 127. The exemplary embodiment of the holder 120 illustrated herein is made of an elastomeric material such as plastic. The spiral fingers 122 are flexible and may be designed to hold any nozzle tip 112 in place more firmly and require less force to insert or remove the nozzle tip 112 than in previous designs. The holder disclosed herein may be made out of plastic for strength and repeated durability and may be used for holding many different types of articles besides nozzle tips.

Referring to FIG. 7A, the exemplary holder 120 includes the spiral fingers 122 spiraling into the bore 126 from a circular radially inner boundary 132 of the rim 124 around the bore 126. The spiral fingers 122 spiral into the bore 126 and narrow down from wide circular finger bases 130 along the inner boundary 132 and are evenly or equiangularly spaced circumferentially around the bore 126. The spiral fingers 122 grip and hold the nozzle tip 112 in place. The spiral fingers 122 may have scalloped ends 136 to provide additional gripping capability. The scalloped ends 136 may have curved or circular contact or gripping surfaces 140 that may be circularly circumscribed about the axis 127. The circular contact or gripping surfaces 140 define a cylindrical bore core 142 circumscribing the axis 127.

Nozzle tips come in different angular degree spray widths to tackle different types of work surfaces, dirt and grime. They are typically located on the pump/motor frame of the pressure washer unit. If you need to change a tip, this could be a 50 foot walk back to the pump or maybe even a trip down the ladder. By storing or holding the nozzle tips on the wand, they are within easy reach at all times.

The accessory mount 10 can be configured to suit the operators needs. The operator can remove the hand grip and wheeled support and just use the nozzle tip holder or just use as a flashlight holder. Or the operator could remove the wheeled support and nozzle tip holder and simply use it with only the hand grip portion. The wheeled support can remain attached if the operator only wants to use the hand grip.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

What is claimed is:

1. An accessory mount comprising:
a clamp including upper and lower clamp bodies,
a clamp bolt or a clamp threaded shank attached to and extending away from a clamp knob for securing together the upper and lower clamp bodies, and
a means for removably mounting one or more accessories on one of the upper and lower clamp bodies.

2. The accessory mount as claimed in claim 1 further comprising the accessories including a detachable and angularly adjustable hand grip.

3. The accessory mount as claimed in claim 2 further comprising:
mating rosettes for pivotably mounting the hand grip to one of the upper and lower clamp bodies,
the mating rosettes including a body rosette on one of the upper and lower clamp bodies and an accessory rosette on the hand grip, and
a mounting threaded shank disposed through an aperture in the hand grip and attached to and extending away from a mounting knob for securing together the mating rosettes.

4. The accessory mount as claimed in claim 3 further comprising an attachment including a strut and a connector for removably mounting the strut to the hand grip.

5. The accessory mount as claimed in claim 4 further comprising the attachment being a wheeled support including a wheel rotatably supported at a bottom end of the strut.

6. The accessory mount as claimed in claim 4 further comprising the attachment being mounted at a bottom end of the strut, the attachment being chosen from a group of attachments, the group comprising a squeegee, a brush, and a scraper.

7. The accessory mount as claimed in claim 1 further comprising the accessories including a mounting block carrying at least one nozzle tip holder and/or a flashlight holder.

8. The accessory mount as claimed in claim 7 further comprising:
a hanger having a hoop or attachment slot on the clamp,
the hanger operable to receive a hook on the mounting block, and
a quick release thumb tab on the hook operable to be disposed in the attachment slot and engage the hanger.

9. The accessory mount as claimed in claim 7 further comprising the nozzle tip holder including a bore circumscribing an axis and extending through the holder and flexible spiral holding fingers extending radially inwardly and circumferentially into the bore from a rim around the bore.

10. The accessory mount as claimed in claim 9 further comprising the spiral fingers spiraling into the bore, narrowing down from wide circular finger bases along an inner boundary around the bore, and spaced evenly or equiangularly circumferentially around the inner boundary.

11. The accessory mount as claimed in claim 10 further comprising:
the spiral fingers including scalloped ends with curved or circular gripping surfaces,
the circular gripping surfaces circularly circumscribed about the axis, and
the circular gripping surfaces defining a cylindrical bore core circumscribing the axis.

12. The accessory mount as claimed in claim 9 further comprising the flashlight holder including at least two longitudinally spaced apart elastic loops attached to the mounting block.

13. The accessory mount as claimed in claim 12 further comprising:
a hanger having a hoop or attachment slot on the clamp,
the hanger operable to receive a hook on the mounting block, and
a quick release thumb tab on the hook operable to be disposed in the attachment slot and engage the hanger.

14. The accessory mount as claimed in claim 2 further comprising the upper and lower clamp bodies including upper and lower V-shaped clamp walls respectively.

15. The accessory mount as claimed in claim 14 further comprising:
mating rosettes for pivotably mounting the hand grip to one of the upper and lower clamp bodies,
the mating rosettes including a body rosette on one of the upper and lower clamp bodies and an accessory rosette on the hand grip, and
a mounting threaded shank disposed through an aperture in the hand grip and attached to and extending away from a mounting knob for securing together the mating rosettes.

16. The accessory mount as claimed in claim 15 further comprising an attachment including a strut and a connector for removably mounting the strut to the hand grip.

17. The accessory mount as claimed in claim 16 further comprising the attachment being a wheeled support including a wheel rotatably supported at a bottom end of the strut.

18. A pressure washer wand and accessory mount assembly comprising:
an accessory mount including a clamp having upper and lower clamp bodies clamped around a longitudinally extending tube of a pressure washer wand,
a clamp bolt or a clamp threaded shank attached to and extending away from a clamp knob for securing together the upper and lower clamp bodies, and
a means for removably mounting one or more accessories on at least one of the upper and lower clamp bodies.

19. The assembly as claimed in claim 18 further comprising the accessories including a detachable and angularly adjustable hand grip.

20. The assembly as claimed in claim 19 further comprising the upper and lower clamp bodies including upper and lower V-shaped clamp walls respectively clamped around the longitudinally extending tube.

21. The assembly as claimed in claim 20 further comprising:
mating rosettes for pivotably mounting the hand grip to one of the upper and lower clamp bodies,
the mating rosettes including a body rosette on the lower clamp body and an accessory rosette on the hand grip, and
a mounting threaded shank disposed through an aperture in the hand grip and attached to and extending away from a mounting knob for securing together the mating rosettes.

22. The assembly as claimed in claim 21 further comprising:
an attachment including a strut and a connector for removably mounting the strut to the hand grip,
the attachment being mounted at a bottom end of the strut, and
the attachment being chosen from a group of attachments, the group comprising a squeegee, a brush, and a scraper.

23. The assembly as claimed in claim 21 further comprising:
an attachment including a strut and a connector for removably mounting the strut to the hand grip,
the attachment being a wheeled support including a wheel rotatably supported at a bottom end of the strut, and
the wheeled support mounted at a bottom end of the strut.

24. The assembly as claimed in claim 21 further comprising the accessories including a mounting block carrying at least one nozzle tip holder and/or a flashlight holder.

25. The assembly as claimed in claim 24 further comprising:
a hanger having a hoop or attachment slot on the clamp,
the hanger operable to receive a hook on the mounting block, and
a quick release thumb tab on the hook operable to be disposed in the attachment slot and engage the hanger.

26. The assembly as claimed in claim 24 further comprising the nozzle tip holder including a bore circumscribing an axis and extending through the holder and flexible spiral holding fingers extending radially inwardly and circumferentially into the bore from a rim around the bore.

27. The assembly as claimed in claim 26 further comprising the spiral fingers spiraling into the bore, narrowing down from wide circular finger bases along an inner boundary around the bore, and spaced evenly or equiangularly circumferentially around the inner boundary.

28. The assembly as claimed in claim 27 further comprising:
the spiral fingers including scalloped ends with curved or circular gripping surfaces,
the circular gripping surfaces circularly circumscribed about the axis, and
the circular gripping surfaces defining a cylindrical bore core circumscribing the axis.

29. The assembly as claimed in claim 26 further comprising the flashlight holder including at least two longitudinally spaced apart elastic loops attached to the mounting block.
